(19) United States
(12) Patent Application Publication
(10) Pub. No.: US 2015/0057121 A1
(43) Pub. Date: Feb. 26, 2015

(54) Planetary Gear Assembly of a Starter Motor

(71) Applicant: Remy Technologies, L.L.C., Pendleton, IN (US)

(72) Inventor: Paul Martin Dedrich, Anderson, IN (US)

(73) Assignee: Remy Technologies, L.L.C., Pendleton, IN (US)

(21) Appl. No.: 13/971,311

(22) Filed: Aug. 20, 2013

(51) Int. Cl. F16H 1/28; F02N 11/00

(52) U.S. Cl. CPC F16H 1/28; F02N 11/00
USPC 475/149

(57) ABSTRACT

A starter motor for an engine includes a housing and a planetary gear assembly. The housing defines an interior space. The planetary gear assembly is at least partially positioned in the interior space and includes (i) a sun gear having a first number of gear teeth equal to a pitch diameter of the sun gear, (ii) a ring gear having a second number of gear teeth equal to a pitch diameter of the ring gear, and (iii) no more than two planet gears each connected to a planetary gear carrier. Each planet gear of the no more than two planet gears has a third number of gear teeth equal to a pitch diameter of the no more than two planet gears.

### FIELD

The present disclosure relates to the field of starter motor assemblies for starting an engine, and particularly to a clutch portion of the starter motor assembly, which includes a planetary gear assembly.

### BACKGROUND

A starter motor assembly is typically used to start an internal combustion engine, such as an engine in a typical passenger vehicle. The conventional starter motor assembly broadly includes an electric motor coupled to a drive mechanism. The electric motor is electrically connectable to a battery, and the drive mechanism is mechanically coupled to the engine. The electric motor is energized by the battery upon the closing of an ignition switch. The drive mechanism transmits torque generated by the electric motor to a flywheel of the engine, thereby rotating the flywheel and causing the engine to start. After the engine is started, the ignition switch is opened and the electric motor becomes deenergized.

Typically, the drive mechanism includes a gear assembly having an input and an output. The input is mechanically connected to the electric motor and the output is mechanically connected to the engine (i.e. the flywheel of the engine). The gear ratio between the input and the output of the gear mechanism typically causes the output to rotate with less angular velocity than the input. Accordingly, one function of the gear mechanism is to reduce the angular velocity of the motor to an angular velocity that is suitable for rotating the flywheel.

During engine starting, torque form the engine is sometimes briefly transferred to the starter motor assembly (including the gear assembly) before decoupling of the gear assembly from the flywheel occurs. For at least this reason, it is desirable for the gear assembly to be sufficiently robust so as to withstand any brief pulses of torque from engine. As is typically the case, making an assembly robust increases manufacturing cost of the assembly due to increased material costs, among other reasons.

Therefore, it is advantageous to provide a starter motor assembly including a gear assembly that is sufficiently robust but that minimizes manufacturing costs.

### SUMMARY

In accordance with one embodiment of the disclosure, a starter motor for an engine includes a housing and a planetary gear assembly. The housing defines an interior space. The planetary gear assembly is at least partially positioned in the interior space and includes a sun gear defining an axis of rotation, a ring gear, a planetary gear carrier configured to rotate about the axis of rotation, and no more than two planet gears rotatably connected to the planetary gear carrier and configured to mesh with the sun gear and the ring gear. A gear ratio (“GR”) between the sun gear and the ring gear is based on the following formula:

$$GR = \frac{{N}_{R}}{{N}_{S}} + 1.$$

The variable “N_{R}” is a number of gear teeth of the ring gear, and the variable “N_{S}” is a number of gear teeth of the sun gear.

According to another embodiment of the disclosure, a starter motor for an engine includes a housing and a planetary gear assembly. The housing defines an interior space. The planetary gear assembly is at least partially positioned in the interior space and includes (i) a sun gear having a first number of gear teeth equal to a pitch diameter of the sun gear, (ii) a ring gear having a second number of gear teeth equal to a pitch diameter of the ring gear, and (iii) no more than two planet gears each connected to a planetary gear carrier. Each planet gear of the no more than two planet gears has a third number of gear teeth equal to a pitch diameter of the no more than two planet gears.

According to yet another embodiment of the disclosure, a planetary gear assembly for a starter motor includes a sun gear, a ring gear, a planetary gear carrier, no more than two planet gears, and no more than two bearing members. The sun gear defines an axis of rotation. The planetary gear carrier is configured to rotate about the axis of rotation. Each planet gear is configured to mesh with the sun gear and the ring gear, and each planet gear includes a bearing surface defining a bearing passage. Each bearing member includes a tube structure and at least two ball bearings. The tube structure extends axially from the planetary gear carrier and includes an interior surface defining an axial cavity and an exterior surface. The tube structure defines at least two bearing passages extending between the interior surface and the exterior surface. Each ball bearing is at least partially positioned within one of the bearing passages, and at least a portion of each ball bearing extends radially away from the exterior surface. Each tube structure is configured to extend at least partially through one of the bearing passages. The at least two ball bearings are positioned against one of the bearing surfaces

The above described features and advantages, as well as others, will become more readily apparent to those of ordinary skill in the art by reference to the following detailed description and accompanying drawings. While it would be desirable to provide a starter motor and/or a planetary gear assembly that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a cross sectional view of a starter motor assembly including a clutch and a planetary gear assembly, as described herein;

FIG. 2 is a cross sectional view taken along the line 2-2 of FIG. 1 showing the clutch and the planetary gear assembly;

FIG. 3 is an elevational view showing the planetary gear assembly of FIG. 1;

FIG. 4 is a perspective view of a bearing member of the planetary gear assembly of FIG. 1;

FIG. 5 is an elevational view showing a planet gear of the planetary gear assembly of FIG. 1 connected to the bearing member of FIG. 4;

FIG. 6 is cross sectional view taken along the line 6-6 of FIG. 5; and

FIG. 7 is a cross sectional view of another embodiment of a bearing member of the planetary gear assembly.

### DETAILED DESCRIPTION

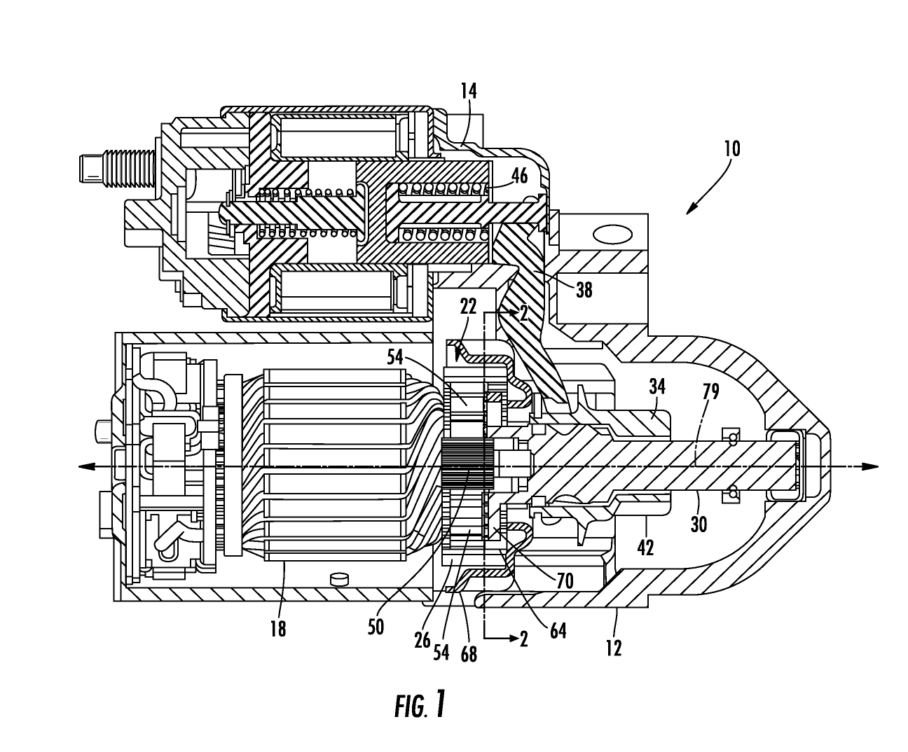

As shown in FIG. 1, a starter motor 10 includes a housing 12, a solenoid 14, a rotor 18, a gear assembly 22, a clutch 26, a shaft 30, and a pinion 34, among other components. The housing 12 is typically connected to an engine (not shown), such as an internal combustion engine of a vehicle (also not shown). The housing 12 is formed from metal, such as steel, aluminum, or any desired material.

The solenoid 14 is at least partially positioned within the housing 12. When the solenoid 14 is electrically energized it is configured to cause a lever 38 to move the pinion 34 axially along the shaft 30 until gear teeth 42 on the pinion engage with gear teeth (not shown) on a flywheel of the engine. When electrical energy to the solenoid 14 is removed, a return spring 46 within the solenoid 14 is configured to return the pinion 34 and the lever 38 to their original positions, shown in FIG. 1. The solenoid 14 is provided as any solenoid, as desired by those of ordinary skill in the art.

The rotor 18 is also at least partially positioned within the housing 12. The rotor 18 rotates relative to the housing 12 in response to the rotor 18 being supplied with electrical energy. The rotor 18 is provided as any rotor, as desired by those of ordinary skill in the art.

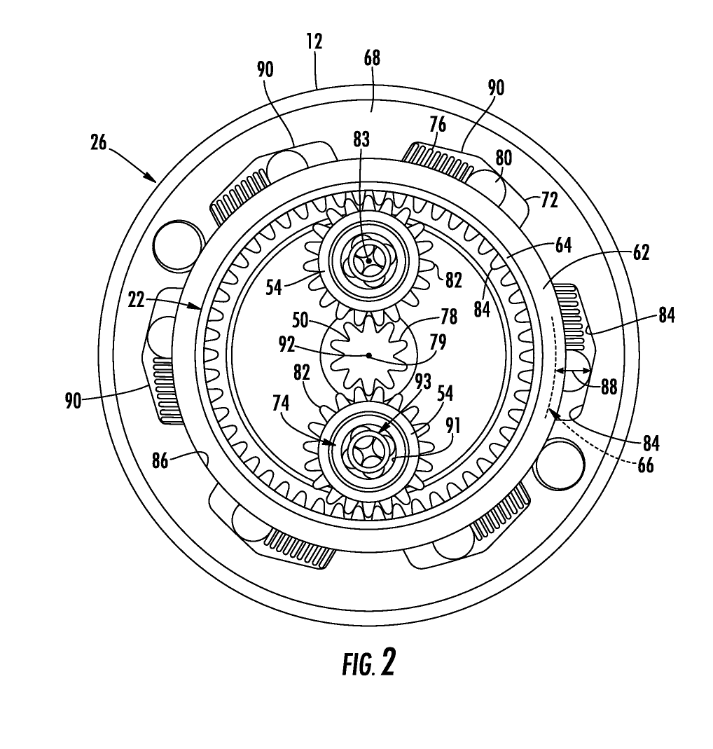

With reference to FIG. 2, the gear assembly 22 is a planetary gear assembly, which includes a sun gear 50, two planet gears 54, a ring gear 64, a planetary gear carrier 70 (FIG. 1), and bearing members 74. The gears 50, 54, and 64 of the gear assembly 22 are formed from forged steel, other metals, an oil-resistant grade of nylon 6-6, or any other material (or combination thereof) as desired by those of ordinary skill in the art.

The sun gear 50 is a generally circular gear having a plurality of external gear teeth 78. The sun gear 50 is mechanically coupled to the rotor 18 and is configured to rotate about an axis of rotation 79 (also shown in FIG. 1). The rotor 18 and the sun gear 50 rotate with the same angular velocity. In one embodiment, the sun gear 50 is integrally formed as a monolithic part with the rotor 18. In another embodiment, the sun gear 50 is connected to the rotor 18 with welding, epoxy, or another suitable bonding agent/process as is appropriate for the material of the rotor and the sun gear.

The planet gears 54 are also generally circular gears that define a plurality of external gear teeth 82 and an axis of rotation 83. The gear teeth 82 of the planet gears 54 are configured to mesh with the gear teeth 78 of the sun gear 50. The gear assembly 22 includes no more than two of the planet gears 54. Specifically, in one embodiment, the gear assembly 22 includes only two of the planet gears 54. In another embodiment, the gear assembly 22 includes only one of the planet gears 54.

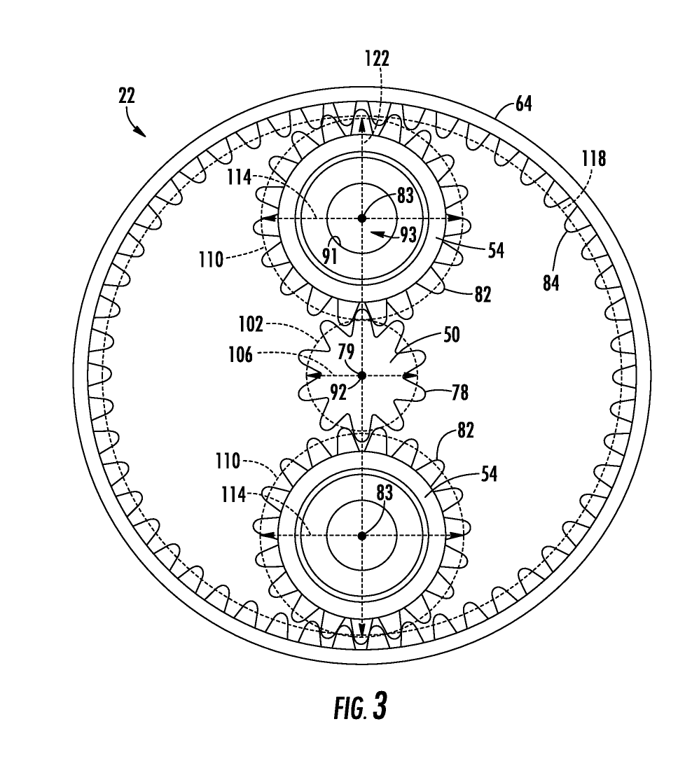

The planet gears 54 are rotatably connected to the planetary gear carrier 70 by the bearing members 74 (described in detailed below). To this end, the planet gears 54 include a bearing surface 91 that defines a bearing passage 93 (see also FIG. 3). The bearing surface 91 is a generally cylindrical surface. The bearing passage 93 extends at least partially through the planet gear 54 and is centered about the axis of rotation 83. In another embodiment, the gear assembly 22 does not include the bearing members 74, and the planet gears 54 are rotatably connected to the planetary gear carrier 70 with any desired bearing/connection member, such as, for example, needle bearings (not shown).

The planetary gear carrier 70 is formed on an end (right end in FIG. 1) of the shaft 30. The planetary gear carrier 70 is integrally formed as a monolithic part with the shaft 30 and is also referred to herein as a “flange” of the shaft 30. The planetary gear carrier 70 is configured to rotate about the axis of rotation 79. In another embodiment, the planetary gear carrier 70 is mechanically connected to the shaft 30 instead of being integrally formed.

The ring gear 64 is a generally circular gear defining a plurality of internal gear teeth 84 that are configured to mesh with the gear teeth of the planet gears 54. A center point 92 of the ring gear 64 is aligned with the axis of rotation 79. The ring gear 64 is mechanically connected to the clutch 26.

With continued reference to FIG. 2, the clutch 26 includes an outer clutch member provided as a shell 68, an inner clutch member 62 (which may also be referred to herein as a “collar”), a plurality of springs 76, and a plurality of rollers 80. The shell 68 is fixedly received by the housing 12 and defines a shell opening 86, and a plurality of pockets 72.

The clutch collar 62 is mechanically connected to the ring gear 64 so as to be non-rotatably relative to the ring gear. In other embodiments, however, the clutch collar 62 may be separate from the ring gear 64. The outer surface of clutch collar 62 defines a clutch surface 66.

One of the springs 76 and one of the rollers 80 are positioned in each of the pockets 72 defined by the outer clutch member 68. The springs 76 are oriented within the pockets 72 to bias the rollers 80 in a circumferential direction (i.e. clockwise as viewed in FIG. 2). The springs 76 bias the rollers 80 against walls of the pockets 84 and the clutch surface 66. In the illustrated example, the springs 76 are compression springs, however, in other embodiments the springs may be provided as any type of spring or other biasing member, as may be recognized by those of ordinary skill in the art.

The rollers 80 of the clutch 26 are generally cylindrical elements. The rollers 80 are at least partially positioned within the shell opening 86 and at least partially positioned within the pockets 72. Therefore, the rollers 80 are positioned between the clutch surface 66 and the shell 68.

The position of the rollers 80 within the pockets 72 determines if the clutch 26 is in a locked configuration or an unlocked configuration. When the rollers 80 are positioned toward the center of the pockets 72 (a position that is not shown in the figures) the rollers 80 are free to rotate and, consequently, the clutch collar 62 and the ring gear 64 are free to rotate relative to the shell 68. This “unlocked” configuration occurs when the ring gear 64 is rotated in a counterclockwise direction relative to the shell 68 in the view of FIG. 2. In this instance, friction between the rollers 80 and the clutch surface 66 cause the rollers 80 to move toward the springs 76 and toward the center of the pockets 72 where the annular distance 88 is greatest.

When there is no relative motion between the ring gear 64 and the shell 68, the springs 76 partially wedge the rollers 80 between the clutch surface 66 and the shell 68. With substantially any clockwise rotation of the clutch collar 62 relative to the shell 68, the rollers 80 become even further wedged between the clutch collar and the shell, thereby preventing any additional relative rotation therebetween. In this “locked” configuration, the clutch collar 62 and the ring gear 64 are locked into synchronous movement with the shell 68, and the ring gear is configured to resist rotation about the axis of rotation 79 in the clockwise direction (as shown in FIG. 2).

When the clutch 26 is in the unlocked configuration, the gear assembly 22 exhibits a gear ratio between the sun gear 50 and the ring gear 64 based on the following formula:

$$GR = \frac{{N}_{R}}{{N}_{S}} + 1$$

In the above formula the gear ratio between the sun gear 50 and the ring gear 64 is represented by the variable “G_{R}”, the number of gear teeth 84 of the ring gear 64 is represented by the variable “N_{R}”, and the number of gear teeth 78 of the sun gear 50 is represented by the variable “N_{S}”. Accordingly, the gear ratio “G_{R}” equals the number of gear teeth of the ring gear “N_{R}” divided by the number of gear teeth of the sun gear “N_{S}” plus one. In one specific embodiment, the number of gear teeth 84 of the ring gear 64 equals sixty-one, the number of gear teeth 78 of the sun gear 50 equal nineteen, and the gear ratio equals approximately 4.2 (i.e. 61/19+1≈4.2). That is, for every 4.2 rotations of the sun gear 50, the ring gear 64 rotates approximately one time. In other embodiments, the sun gear 50 and the ring gear 64 have any number of gear teeth 78, 84 as desired by those of ordinary skill in the art.

The number of gear teeth 82 of the planet gears 54 (“NP”) does not contribute to determining the gear ratio (“GR”). In the specific embodiment described above, however, the number of gear teeth 82 of the planet gears 54 is equal to nineteen. In other embodiments, the planet gears 54 have any number of gear teeth 82 as desired by those of ordinary skill in the art.

As shown in FIG. 3, the gear assembly 22 is shown isolated from the rest of the starter motor 10 to illustrate the pitch diameters of the gears 50, 54, and 64. Also, the bearing members 74 are not shown in FIG. 3. As used herein, the term “pitch diameter” refers to a diameter of a pitch circle. The “pitch circle” of a first gear that is meshed with a second gear refers to a circle defined by points/regions of contact between gear teeth of the first gear and gear teeth of the second gear as the gears are rotated. The pitch circle of a gear is concentric with an axis of rotation of the gear. When two gears are meshed, their respective pitch circles are configured to contact each other at at least one point.

With regard to the gear assembly 22, the sun gear 50 defines a pitch circle 102 having a pitch diameter 106. The planet gears 54 each define a pitch circle 110 having a pitch diameter 114. And the ring gear 64 defines a pitch circle 118 having a pitch diameter 122. In one embodiment, the gears 50, 54, and 64 have pitch diameters with the following magnitudes. The pitch diameter 106 is of the sun gear 50 is equal to the number of gear teeth 78 of the sun gear 50 (i.e. “N_{S}”). The pitch diameter 114 of the planet gears 54 is equal to the number of gear teeth 82 of the planet gears (i.e. “N_{P}”). The pitch diameter 122 of the ring gear 64 is equal to the number of gear teeth 84 of the ring gear (i.e. “N_{R}”). This configuration of pitch diameters results in a robust gear assembly 22, even when the gear assembly includes only two of the planet gears 54.

In one specific embodiment, the pitch diameter 106 of the sun gear 50 is equal to nineteen millimeters and N_{S} equals nineteen, the pitch diameter 114 of the planet gears 54 equals nineteen millimeters and N_{P} equals nineteen, and the pitch diameter 122 of the ring gear 64 equals sixty-one millimeters and N_{R} equal sixty-one. Accordingly, each pitch diameter 106, 114, and 122 has the same unit of measurement; namely, millimeters in this exemplary embodiment. In other embodiments, the pitch diameters 106, 114, and 122 are any magnitude of any unit(s) of measurement, as desired by those of ordinary skill in the art.

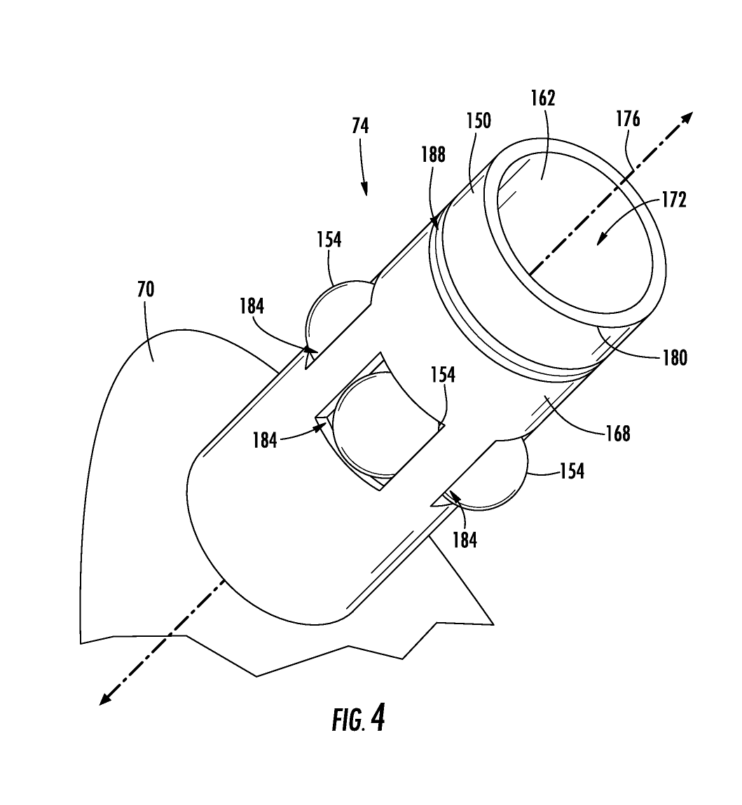

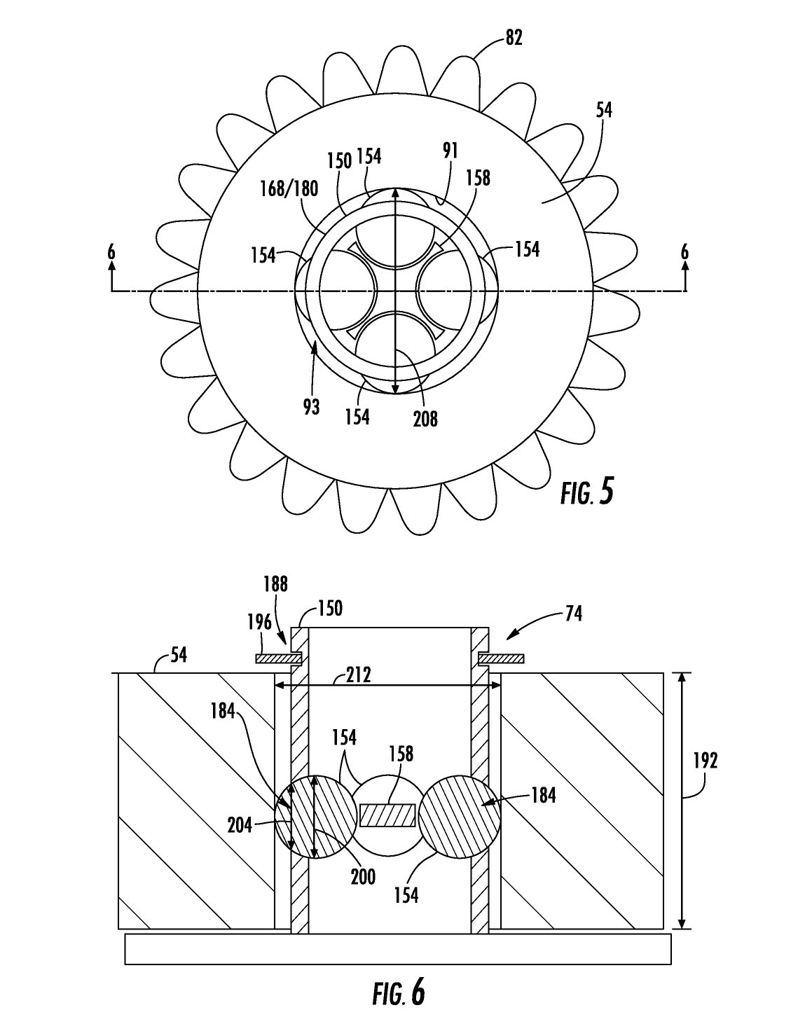

As shown in FIG. 4, one of the bearing members 74 is connected to the planetary gear carrier 70 and its associated planet gear 54 is not shown. Each bearing member 74 is substantially identical. The bearing member 74 includes a tube structure 150, a plurality of ball bearings 154, and a spacer structure 158 (FIG. 5).

The tube structure 150 is generally cylindrical and is connected to the planetary gear carrier 70. The tube structure 150 includes an interior surface 162 and an exterior surface 168. The tube structure 150 is formed from steel. In another embodiment, the tube structure 150 is formed from any other material as desired by those of ordinary skill in the art.

The interior surface 162 defines an axial cavity 172 that extends through the tube structure 150 from an end of the tube structure connected to the planetary carrier 70 to an opposite end of the tube structure that is spaced apart from the planetary carrier. A center axis 176 of the tube structure 150 extends through the axial cavity 172 and is aligned with the axis of rotation 83 of the planet gear 54 that is associated with it.

The exterior surface 168 defines an exterior periphery 180 of the tube structure 150. The exterior periphery 180 is generally circular (see FIG. 5).

The tube structure 150 further defines a plurality of passages 184 and a groove 188. In the embodiment illustrated in FIGS. 4-6, the tube structure 150 defines four of the passages 184 (only three are visible in FIG. 4). Each passage 184 extends completely through the tube structure 150 to the axial cavity 172, and extends between the interior surface 162 and the exterior surface 168. The passages 184 are shown as defining an approximately square periphery. The passages 184 are evenly spaced apart from each other by approximately ninety degrees. In other embodiments, the tube structure 150 defines between one and ten of the passages 184, and the passages define a periphery of any shape as desired by those of ordinary skill in the art. For example, the passages 184 may define a generally rectangular periphery or a generally round periphery.

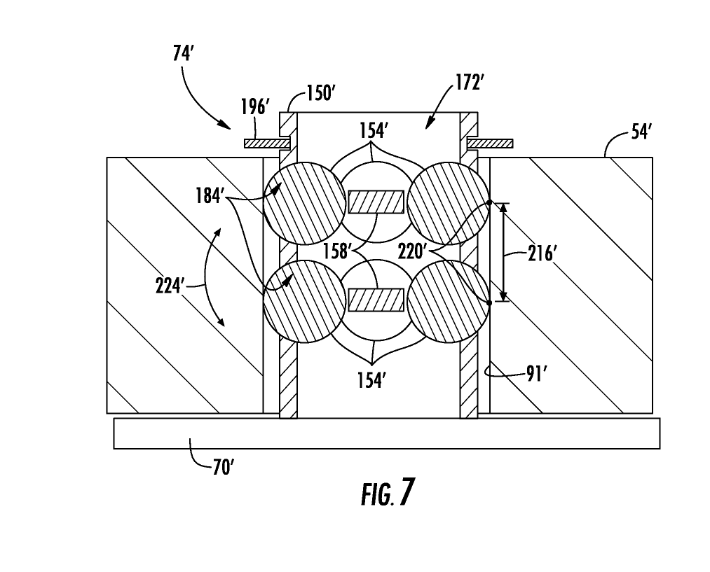

The groove 188 is a circumferential groove around the tube structure 150. The groove 188 is spaced apart from the planetary gear carrier 70 by at least a thickness 192 (FIG. 6) of the planetary gear 54. The groove 188 is configured to receive a snap ring 196 (FIG. 6) or any other retention structure as desired by those of ordinary skill in the art.

The bearings 154 are spherical ball bearings formed from steel or any other desired material. The bearings 154 are partially positioned within the cavity 172 and are partially positioned within the passages 184. Additionally, each bearing 154 extends radially away from the exterior surface 168. The bearings 154 are sized larger than the passages 184 so that the bearings are prevented from passing through the passages. In particular, a diameter 200 (FIG. 6) of the bearings 154 is less than a minimum width 204 (FIG. 6) of the passages 184 to prevent the bearings from exiting the cavity 172 through the passages. The bearing member 74 includes one bearing 154 for each passage 184. In the embodiment of FIG. 4, the bearing member 74 includes four of the bearings 154. Lubrication is provided in the cavity 172 to reduce friction as the bearings 154 are moved relative to the tube structure 150.

As shown in FIG. 5, the spacer structure 158 is positioned in the cavity 172 between the bearings 154. The spacer structure 158 is configured to position the bearings 154 against the tube structure 150 so that the bearings at least partially extend through the passages 184. The spacer structure 158 is generally cross-shaped and is formed form steel or any other material as desired by those of ordinary skill in the art.

With reference to FIGS. 5 and 6, one of the planet gears 54 is shown connected to the bearing member 74. When the planet gear 54 is connected the tube structure 150, the tube structure is configured to extend at least partially through the bearing passage 93 so that each bearing 154 is positioned in the bearing passage against the bearing surface 91. A width 208 (FIG. 5) extends from one bearing 154 to an opposite bearing 154. The width 208 is slightly greater than a diameter 212 (FIG. 6) of the bearing passage 93. Accordingly, a friction fit is established between the bearing surface 91 and the bearings 154. Also, the split ring 196 is seated in the groove 188 to prevent the planet gear 54 from moving off the bearing member 74 in the upward direction (as shown in FIG. 6).

In operation, the motor starter 10 is activated to start the engine to which it is connected. When the motor starter 10 is activated, typically by a user closing an ignition switch (not shown), the solenoid 14 is activated and causes the pinion 34 to move into engagement with the flywheel of the engine (not shown). Next or at the same time, the rotor 18 is supplied with electrical energy and begins to rotate.

With reference to FIG. 2, clockwise rotation of the rotor 18 is transferred to the sun gear 50. Since the shell 68 is fixed to the housing 12, the rotation of the sun gear 50 causes rotation of the planet gears 54, the planetary gear carrier 70 (FIG. 1), the shaft 30 (FIG. 1), and the pinion 34 (FIG. 1). In particular, the planet gears 54 rotate about the bearing members 74. The shaft 30 and the pinion 34 are rotated in the same direction as the rotor 18, but at a reduced rotational speed due to the reduction action of the gear assembly 22. The ring gear 64 and the clutch collar 62 are urged in the direction of rotation of the rotor 18 (i.e. clockwise); however, the ring gear and clutch collar do not rotate (or rotate for only a few degrees). Instead, as the ring gear 64 is urged in the clockwise direction, the clutch 26 enters the locked configuration, thereby preventing rotation of the ring gear. This causes the rollers 80 to become wedged between the pocket walls 90 and the clutch surface 66 and exert a pressure on the clutch surface and the pocket walls, as described above.

After the engine is started, the engine rotates the flywheel faster than the pinion 34 can drive it; therefore, the flywheel begins to drive the pinion in the clockwise direction. This driving action of the pinion 34 is communicated back to the planet gears 54 through the shaft 30 and the carrier 70. When this happens, the clutch 26 disengages the pinion 34 from the rotor 18 to prevent damage to the starter motor 10. In particular, the driving action of the flywheel causes the ring gear 64 and the clutch collar 62 to rotate in the counterclockwise direction, which causes the clutch 26 to enter the unlocked configuration. The rotation of the clutch collar 62 in the counterclockwise direction dislodges the rollers 80 from the wedged orientation against the biasing force of the springs 76 and enables the ring gear 64 to rotate. Therefore, when the clutch 26 is in the unlocked configuration the rotor 18 is not driven by the flywheel of the operating engine. The ring gear 64 is rotated by the flywheel until the pinion 34 is disengaged from the flywheel by removing the supply of electrical energy from solenoid 14.

FIG. 7 shows another embodiment of a bearing member 74′. The bearing member 74′ is identical to the bearing member 74, except that the bearing member 74′ includes two sets of bearings 154′ (an upper set and a lower set) that are axially spaced apart from each other by an axial distance 216′. The bearings 154′ contact the bearing surface 91′ of the planet gear 54′. Having two contact points 220′ against the bearing surface 91′ stabilizes the planet gear 54′ relative to the tube structure 150′ and prevents movement of the planet gear in a skewed direction 224′.

While the invention has been described with reference to exemplary embodiments, it will be understood by those skilled in the art that other implementations and adaptations are possible. For example, various changes may be made and equivalent elements may be substituted for elements thereof without departing from the scope of the invention. In addition to the foregoing examples, many modifications may be made to adapt a particular situation or material to the teachings of the invention without departing from the essential scope thereof. Also, there are advantages to individual advancements described herein that may be obtained without incorporating other aspects described herein. Therefore, it is intended that the invention not be limited to the particular embodiment disclosed for carrying out this invention, but that the invention will include all embodiments falling within the scope of the appended claims.

What is claimed is:

1. A starter motor for an engine, comprising:
a housing defining an interior space; and
a planetary gear assembly at least partially positioned in the interior space and including a sun gear defining an axis of rotation, a ring gear, a planetary gear carrier configured to rotate about the axis of rotation, and no more than two planet gears rotatably connected to the planetary gear carrier and configured to mesh with the sun gear and the ring gear, a gear ratio (“GR”) between the sun gear and the ring gear based on the following formula
$$GR = \frac{{N}_{R}}{{N}_{S}} + 1$$
wherein
“N_{R}” is a number of gear teeth of the ring gear, and
“N_{S}” is a number of gear teeth of the sun gear.

2. The starter motor as claimed in claim 1, wherein:
N_{R} is equal to sixty-one, and
N_{S} is equal to nineteen.

3. The starter motor as claimed in claim 2, wherein:
“N_{P}” is a number of gear teeth of each planet gear of the no more than two planet gears, and
N_{P} is equal to nineteen.

4. The starter motor as claimed in claim 3, wherein the ring gear is configured to rotate about the axis of rotation in first direction and is configured to resist rotation about the axis of rotation in a second direction that is opposite to the first direction.

5. The starter motor as claimed in claim 1, wherein the no more than two planet gears are formed from nylon 6-6.

6. The starter motor as claimed in claim 1, wherein:
“N_{P}” is a number of gear teeth of each planet gear of the no more than two planet gears,
N_{S} is equal to a pitch diameter of the sun gear,
N_{R} is equal to a pitch diameter of the ring gear, and
N_{P} is equal to a pitch diameter of each planet gear.

7. A starter motor for an engine, comprising:
a housing defining an interior space; and
a planetary gear assembly at least partially positioned in the interior space and including (i) a sun gear having a first number of gear teeth equal to a pitch diameter of the sun gear, (ii) a ring gear having a second number of gear teeth equal to a pitch diameter of the ring gear, and (iii) no more than two planet gears each connected to a planetary gear carrier, each planet gear of the no more than two planet gears having a third number of gear teeth equal to a pitch diameter of the no more than two planet gears,
wherein the pitch diameter of the sun gear, the pitch diameter of the ring gear, and the pitch diameter of the planet gears each have the same unit of measurement.

8. The starter motor as claimed in claim 7, wherein:
the unit of measurement is millimeters,
the first number of gear teeth of the sun gear is equal to nineteen,
the pitch diameter of the sun gear is equal to nineteen millimeters,
the second number of gear teeth of the ring gear is equal to sixty-one,
the pitch diameter of the ring gear is equal to sixty-one millimeters,
the third number of gear teeth of the no more than two planet gears is equal to nineteen, and
the pitch diameter of the no more than two planet gears is equal to nineteen millimeters.

9. The starter motor as claimed in claim 7, wherein the no more than two planet gears are at least partially formed from 6-6 nylon.

10. The starter motor as claimed in claim 7, wherein:
a gear ratio (“GR”) between the sun gear and the ring gear is based on the following formula
$$GR = \frac{{N}_{R}}{{N}_{S}} + 1$$
“N_{R}” is a number of teeth of the ring gear, and
“N_{S}” is a number of teeth of the sun gear.

11. The starter motor as claimed in claim 10, wherein:
N_{R} is equal to sixty-one, and
N_{S} is equal to nineteen.

12. The starter motor as claimed in claim 11, wherein:
“N_{P}” is a number of teeth of each planet gear of the no more than two planet gears, and
N_{P} is equal to nineteen.

13. The starter motor as claimed in claim 7, wherein the ring gear is configured to rotate about the axis of rotation in first direction and is configured to resist rotation about the axis of rotation in a second direction that is opposite to the first direction.

14. A planetary gear assembly for a starter motor, comprising:
a sun gear defining an axis of rotation;
a ring gear;
a planetary gear carrier configured to rotate about the axis of rotation;
no more than two planet gears, each planet gear being configured to mesh with the sun gear and the ring gear, and each planet gear including a bearing surface defining a bearing passage; and
no more than two bearing members, each bearing member including
a tube structure extending axially from the planetary gear carrier and including an interior surface defining an axial cavity and an exterior surface, the tube structure defining at least two bearing passages extending between the interior surface and the exterior surface, and
at least two ball bearings, each ball bearing being at least partially positioned within one of the bearing passages, and at least a portion of each ball bearing extending radially away from the exterior surface,
wherein each tube structure is configured to extend at least partially through one of the bearing passages, and
wherein the at least two ball bearings are positioned against one of the bearing surfaces.

15. The planetary gear assembly as claimed in claim 14, wherein each ball bearing of the at least two ball bearings is at least partially positioned in the axial cavity.

16. The planetary gear assembly as claimed in claim 14, wherein:
a gear ratio (“GR”) between the sun gear and the ring gear is based on the following formula
$$GR = \frac{{N}_{R}}{{N}_{S}} + 1$$
“N_{R}” is a number of teeth of the ring gear, and
“N_{S}” is a number of teeth of the sun gear.

17. The planetary gear assembly as claimed in claim 16, wherein:
“N_{P}” is a number of gear teeth of each planet gear of the no more than two planet gears,
N_{S} is equal to a pitch diameter of the sun gear,
N_{R} is equal to a pitch diameter of the ring gear, and
N_{P} is equal to a pitch diameter of each planet gear.

18. The planetary gear assembly as claimed in claim 14, wherein a width of the at least two bearing passages is less than a diameter of the at least two ball bearings.

19. The planetary gear assembly as claimed in claim 14, wherein a spacer structure is positioned between the at least two ball bearings.

20. The planetary gear assembly as claimed in claim 14, wherein a first ball bearing of the at least two ball bearings is axially spaced apart from a second ball bearing of the at least two ball bearings.
